(19) United States
(12) Patent Application Publication
(10) Pub. No.: US 2026/0311463 A1
(43) Pub. Date: Oct. 8, 2026

(54) METHOD FOR ADJUSTING PARAMETERS OF IMAGE SIGNAL PROCESSOR, DATA PROCESSING METHOD, AND PRODUCT

(71) Applicant: Shanghai Cambricon Information Technology Co., Ltd., Shanghai (CN)

(72) Inventors: YANCHENG LAN, Shanghai (CN); JINSONG LIU, Shanghai (CN); JING LAN, Shanghai (CN)

(21) Appl. No.: 19/480,484

(22) PCT Filed: Apr. 29, 2024
(86) PCT No.: PCT/CN2024/090486

§ 371 Date: Oct. 31, 2025

(30) Foreign Application Priority Data
May 5, 2023 (CN) 202310499018.X

(51) Int. Cl. G06V 10/774; G06V 10/764; G06V 10/776; G06V 10/82

(52) U.S. Cl. CPC G06V 10/774; G06V 10/764; G06V 10/776; G06V 10/82

(57) ABSTRACT

An electronic device may be included in a computation processing apparatus of a combined processing apparatus, which may include one or more computing apparatuses. The combined processing apparatus may also include an interface apparatus and other processing apparatus. The computation processing apparatus interacts with other processing apparatus to jointly complete user specified computing operations. The combined processing apparatus may also include a storage apparatus, which is connected to the computation processing apparatus and other processing apparatuses respectively, for storing data of the computation processing apparatus and other processing apparatus. The data style of the learnable ISP may be normalized to the data style of the training domain dataset, which is beneficial for improving the actual inference performance of the target network model.

### CROSS REFERENCE TO RELATED APPLICATION AND CLAIM OF PRIORITY

This application claims benefit under 35 U.S.C. 119, 120, 121, or 365(c), and is a National Stage entry from International Application No. PCT/CN2024/090486 filed on Apr. 29, 2024, which claims priority to the benefit of Chinese Patent Application No. 202310499018.X filed on May 5, 2023 in the China Intellectual Property Office, the entire contents of which are incorporated herein by reference.

### BACKGROUND

### 1. TECHNICAL FIELD

The present disclosure generally relates to the field of image processing technology. More specifically, the present disclosure relates to a method for adjusting parameters of an image signal processor, a data processing method, an electronic device, and a computer-readable storage medium.

### 2. BACKGROUND ART

Current mainstream computer vision algorithms are typically deep learning models trained based on a large amount of data. These deep learning models typically assume that the data used during training and inference have the same image style. However, this is not always the case in practice. In the scenario where deep learning models execute computer vision task processing based on image data output by an image signal processor (ISP), when the lenses, image sensors, and the ISP used in actual deployment are different from those used during deep learning model training, the inference data style of the deep learning model will be different from the training data style, which will in turn have a negative impact on the actual inference performance of the deep learning model.

In view of this, there is an urgent need to provide a solution that is conducive to improving the inference performance of deep learning models in actual deployment scenarios.

### SUMMARY

In order to at least solve one or more of the technical problems mentioned above, the present disclosure provides a method for adjusting parameters of an image signal processor, a data processing method, an electronic device, and a computer-readable storage medium in various aspects.

In a first aspect, the present disclosure provides a method for adjusting parameters of an image signal processor, including: obtaining a sample dataset formed from raw image data collected via a target lens and a target image sensor; obtaining a training domain dataset for training a target network model; training a learnable image signal processing model using the sample dataset and the training domain dataset; and configuring parameters of the trained learnable image signal processing model to the image signal processor.

In a second aspect, the present disclosure provides a data processing method, including: obtaining raw data to be processed collected via a target lens and a target image sensor; and processing the raw data to be processed using an image signal processor whose parameters have been adjusted using the method for adjusting parameters of the image signal processor described in the previous and subsequent embodiments, to obtain target image data.

In a third aspect, the present disclosure provides an electronic device, including: a processor configured to execute program instructions; and a memory configured to store the program instructions, which, when loaded and executed by the processor, enable the processor to execute the method for adjusting parameters of the image signal processor as described in the previous and subsequent embodiments, or the data processing method as described in the previous and subsequent embodiments.

In a fourth aspect, the present disclosure provides a computer-readable storage medium having computer-readable instructions stored thereon, which, when executed by one or more processors, implement the method for adjusting parameters of the image signal processor as described in the previous and subsequent embodiments, or the data processing method as described in the previous and subsequent embodiments.

Through the solution of the present disclosure briefly described above, a learnable image signal processing model may be trained using a sample dataset collected via a target lens and a target sensor as well as a training domain dataset to normalize the data style of the learnable image signal processing model to the data style of the training domain dataset, thereby facilitating the improvement of the actual inference performance of the target network model.

### BRIEF DESCRIPTION OF THE DRAWINGS

By reading the following detailed description with reference to the accompanying drawings, the above-mentioned and other objects, features and advantages of the exemplary embodiments of the present disclosure will become easier to understand. In the accompanying drawings, several embodiments of the present disclosure are shown in an exemplary but not restrictive manner, and the same or corresponding reference numerals indicate the same or corresponding parts of the embodiments.

FIG. 1 illustrates a flowchart of a method for adjusting parameters of an ISP according to an embodiment of the present disclosure.

FIG. 2 illustrates a schematic flowchart of a method including similarity evaluation according to an embodiment of the present disclosure.

FIG. 3 illustrates a flowchart of a method for similarity evaluation based on image feature distribution according to an embodiment of the present disclosure.

FIG. 4 illustrates a flowchart of a data processing method according to an embodiment of the present disclosure.

FIG. 5 illustrates a schematic block diagram of an electronic device according to an embodiment of the present disclosure.

FIG. 6 illustrates a diagram of a structure of a combined processing device according to an embodiment of the present disclosure.

FIG. 7 illustrates a schematic diagram of a structure of a board card according to an embodiment of the present disclosure.

### DETAILED DESCRIPTION

Technical solutions in embodiments of the present disclosure will be described clearly and completely hereinafter with reference to the drawings in the embodiments of the present disclosure. Obviously, the embodiments to be described are merely some rather than all examples of the present disclosure. All other embodiments obtained by those skilled in the art based on the embodiments of the present disclosure without creative efforts shall fall within the protection scope of the present disclosure.

It should be understood that the terms “including” and “comprising” used in the specification and the claims of the present disclosure indicate the presence of a feature, an entity, a step, an operation, an element, and/or a component described, but do not exclude the existence or addition of one or more other features, entities, steps, operations, elements, components, and/or collections thereof.

It should also be understood that the terms used in the specification of the present disclosure are merely intended to describe specific embodiments rather than to limit the present disclosure. As being used in the specification and the claims of the disclosure, unless the context clearly indicates otherwise, the singular forms “a”, “an”, and “the” are intended to include the plural forms. It should also be understood that the term “and/or” used in the specification and the claims of the present disclosure refers to any and all possible combinations of one or more of relevant listed items and includes these combinations.

As being used in this specification and the claims, the term “if” can be interpreted as “when”, or “once” or “in response to a determination” or “in response to a detection” depending on the context. Similarly, the phrases “if it is determined” or “if [described condition or event] is detected” may be interpreted to mean “upon determination” or “in response to determination” or “upon detection of [described condition or event]” or “in response to detection of [described condition or event],” depending on the context.

The inventors of the present disclosure have found that one solution to the problem of inconsistent feature distributions between training data and inference data of a deep learning model based on computer vision is to enhance the cross-domain robustness of the deep learning model by training the deep learning model to learn domain invariant features. However, when the lenses, image sensors, or ISPs are replaced with different ones in actual deployment scenarios, it will cause changes in the feature distribution of the inference domain data. According to the above solution, the deep learning model needs to be retrained to maintain its inference performance. If the deep learning model is retrained, it will consume a lot of time and manpower costs.

Based on the above findings, unlike the above solution that retrains the deep learning model to ensure its inference performance in actual deployment, the inventors of the present disclosure have proposed a method that adjusts parameters on the ISP side to effectively improve the inference performance of the deep learning model in actual deployment. Because the solution of the present disclosure eliminates the need to retrain the deep learning model, it helps to save the time and manpower required to repeatedly train the deep learning model. Detailed embodiments of the present disclosure are described below in detail with reference to the accompanying drawings.

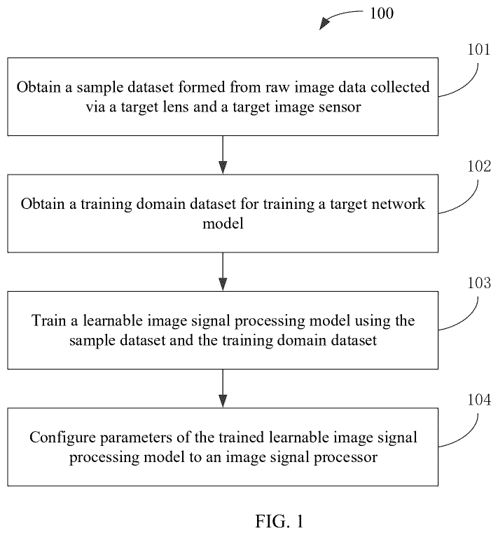

FIG. 1 illustrates a flowchart of a method for adjusting parameters of an ISP according to an embodiment of the present disclosure. As shown in FIG. 1, a method 100 may include: in step 101, obtaining a sample dataset formed from raw image data collected via a target lens and a target image sensor. The raw image data is in data format of raw image format (RAW). The sample dataset may include one or more pieces of raw image data. The target lens and target sensor may be used in conjunction to collect the raw image data. Since the models and configurations of lenses and image sensors used by different manufacturers or in different scenarios vary, the lens and the image sensor at different deployment sides may have different image styles. The target lens and/or target image sensor in the embodiments of the present disclosure may be selected from one or more lenses and/or one or more image sensors used by the target network model in practical deployment as needed.

In some preferred embodiments, the raw image data in the sample dataset may cover various deployment scenarios of the target lens and target image sensor, such as the sample dataset formed from multiple pieces of raw image data collected under different deployment scenarios like different times of the day, varying brightness levels, different weather conditions, and diverse road sections via the target lens and target image sensor, which helps improve the generalization capability of the ISP whose parameters have been adjusted.

Next, in step 102, a training domain dataset for training the target network model may be obtained. In some embodiments, the target network model may include a deep learning model based on computer vision tasks. Computer vision (CV) refers to machine vision that replaces the human eye with cameras and electronic devices to identify, track, and measure targets, and further performs image processing to make electronic devices process them into images that are more suitable for human observation or transmission to instruments for detection. In some embodiments, deep learning models (referred to as CV models) based on computer vision tasks may include one or more of object detection models, object localization models, object segmentation models, and classification models, which are oriented to application scenarios such as automatic driving, road monitoring, and face recognition. The training domain data set is training data used when training the target network model. The style of the training domain dataset determines the data style that the target network model can learn and also determines the data style that the trained target network model is good at inferring.

The process then proceeds to step 103, where a learnable image signal processing model is trained using the sample dataset and the training domain dataset. In some embodiments, the training domain dataset may serve as the target domain to train the learnable image signal processing model (referred to as a learnable ISP), which may serve as a reference target during the training of the learnable ISP. In other embodiments, the learnable ISP may be trained in an unsupervised manner.

In some embodiments, before training the learnable ISP, the method 100 may further include generating the learnable ISP based on the ISP. The ISP may include an intelligent image signal processing unit (AI ISP). A complete imaging system may include a lens, an image sensor, and a backend ISP. Therefore, the ISP performing parameter adjustment in the present embodiment may be the ISP used in conjunction with the target lens and target image sensor mentioned above, or an ISP used by the target network model in actual deployment.

In other embodiments, the learnable ISP may be generated by way of a proxy for the ISP. Specifically, a neural network (e.g., a convolutional neural network) may be used to model the ISP, and the processing flow of the ISP may be fitted by training the neural network. The fitted neural network may act as a proxy for the function of the ISP, thus serving as a learnable ISP.

In some preferred embodiments, generating the learnable ISP based on the ISP may include performing differentiable processing on the ISP to obtain the learnable ISP. The differentiable processing may include performing a differentiable implementation of the ISP using a deep learning framework such as PyTorch or TensorFlow to obtain the learnable ISP. Compared to the way of a proxy for the ISP, the learnable ISP obtained through differentiable processing may maintain high consistency with the hardware ISP (i.e., image signal processor), and will not be affected by changes in the data style of the input data. It may also avoid the problems that may exist in the way of the proxy for the ISP mentioned above, such as difficulty in implementing the proxy and poor generalization ability caused by too many parameters of the ISP and complex functions.

Furthermore, after generating the learnable ISP, the similarity between the image data output by the ISP and the learnable ISP under the same input and configuration may be verified to evaluate matching between the learnable ISP and the ISP. After the similarity between the learnable ISP and the ISP is evaluated to reach a preset standard, the training operation in step 103 may be performed on the learnable ISP.

As further shown in FIG. 1, in step 104, the parameters of the trained learnable ISP may be configured to the ISP. Specifically, the parameters of the trained learnable ISP may be exported and then configured to the ISP hardware for use, thereby completing the parameter adjustment of the ISP.

It may be understood that the ISP whose parameters have been adjusted may normalize the style of the data collected by the target lens and the target sensor to the style of the training domain dataset of the target network model, so that the target network model may still perform inference based on the data style it is good at inferring during actual deployment, thereby improving the inference performance of the target network model during actual deployment.

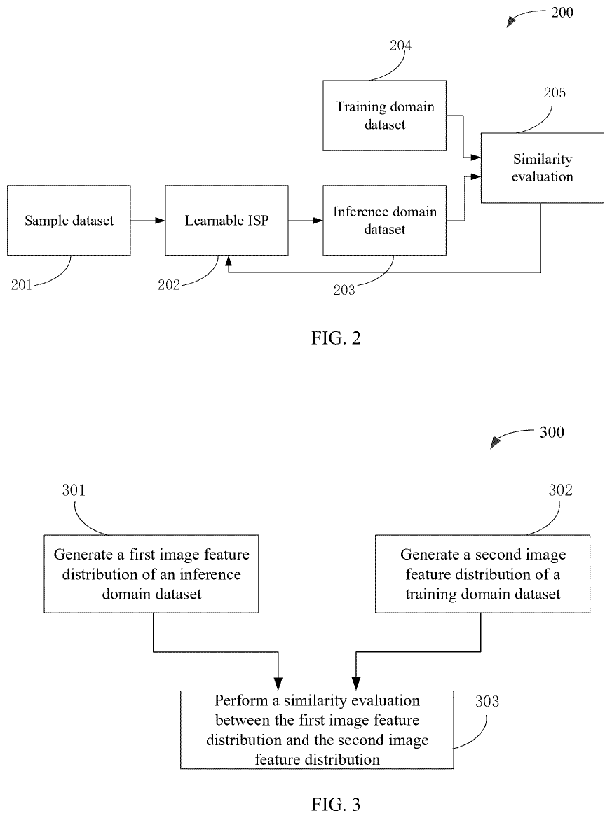

The above describes the method for adjusting the parameters of the ISP according to the embodiment of the present disclosure in conjunction with FIG. 1. It may be understood that the above description is exemplary and not restrictive. For example, in some embodiments, using a sample dataset and a training domain dataset to train a learnable ISP may include: inputting the sample dataset into the learnable ISP to obtain an inference domain dataset; and performing a similarity evaluation on the inference domain dataset and the training domain dataset to adjust parameters of the learnable ISP based on a result of the similarity evaluation. This will be described below with reference to FIG. 2.

FIG. 2 illustrates a schematic flowchart of a method including similarity evaluation according to an embodiment of the present disclosure. As may be seen from the following description, process 200 shown in FIG. 2 may be a specific embodiment of the method 100 described in conjunction with FIG. 1 above. Therefore, the description of the method 100 in conjunction with FIG. 1 above may also apply to the following description of the process 200.

As shown in FIG. 2, the process 200 may include: obtaining a sample dataset 201 collected via a target lens and a target image sensor; and then, inputting the sample dataset 201 into a learnable ISP 202 to obtain an inference domain dataset 203. In some embodiments, the inference domain dataset 203 may include inference image data in the data format of red, green, blue (RGB), where each piece of inference image data may be generated from a corresponding piece of raw image data in the sample dataset 201. The process 200 may also include: obtaining a training domain dataset 204 for training the target network model.

After obtaining the inference domain dataset 203 and the training domain dataset 204, the process 200 may further include: performing a similarity evaluation 205 on the inference domain dataset 203 and the training domain dataset 204. The similarity evaluation 205 may be an evaluation of the inference domain dataset 203 and the training domain dataset 204 on the dataset dimension. By performing the similarity evaluation 205, the learnable ISP 202 may be trained based on a result of the similarity evaluation. For example, parameters of the learnable ISP may be adjusted based on the result of the similarity evaluation. After one or more parameter optimizations, the learnable ISP may reduce or even eliminate the domain differences between the inference domain dataset 203 and the training domain dataset 204, ensuring that the image style of the generated inference domain dataset 203 is highly similar to that of the training domain dataset 204. This enables the trained learnable ISP to have the ability to generate inference data that better aligns with the style of the training domain dataset 204.

In some embodiments, performing the similarity evaluation 205 on the inference domain dataset 203 and the training domain dataset 204 may include the similarity evaluation based on a domain classification network. In other embodiments, the domain classification network may include a classification network such as a visual geometry group (VGG) network model or a ResNet network model or the like, or may include other feasible network structures for image classification. In still other embodiments, the classification network may be modified to a binary classification structure as a domain classification network by modifying the last fully connected layer of the classification network.

Specifically, a generative adversarial network (GAN) may be formed based on the learnable ISP 202 and the domain classification network. In this GAN, the learnable ISP 202 is used to generate the inference domain dataset 203, and the domain classification network is used to discriminate the input data to determine whether the input data belongs to the inference domain dataset 203 or the training domain dataset 204.

Then, the learnable ISP 202 and the domain classification network may be alternately trained, where the domain classification network is discriminatively trained using the inference domain dataset 203 and the training domain dataset 204. In other words, the inference domain dataset 203 and the training domain dataset 204 may be input into the domain classification network to evaluate the similarity between the inference domain dataset 203 and the training domain dataset 204. During the alternately training, the network parameters of one of the learnable ISP 202 and the domain classification network may be fixed, while the network parameters of the other may be updated. This alternating iteration continues until the learnable ISP 202 may capture the feature distribution of the training domain dataset 204, in other words, the inference domain data set 203 with a style highly consistent with that of the training domain data set 204 may be generated.

Furthermore, during the alternately training, other optimization strategies, techniques, and loss functions of the GAN may be employed to enable the learnable ISP 202 and the domain classification network to engage in mutual adversary and further optimization. For example, the inference domain dataset 203 and the training domain dataset 204 may be labeled separately to distinguish whether the data input to the domain classification network comes from the inference domain dataset 203 or the training domain dataset 204, so as to facilitate training of the domain classification network. For another example, a loss function such as, but not limited to, binary cross-entropy (BCE) may be used to train and optimize the learnable ISP 202. The parameters of the trained and converged learnable ISP 202 may be exported and configured to the ISP.

It may be understood that when the domain classification network is discriminatively trained using the inference domain dataset 203 and the training domain dataset 204, the easier it is for the domain classification network to discriminate the source of the input data, the lower the similarity between the inference domain dataset 203 and the training domain dataset 204; and the more difficult it is for the domain classification network to discriminate the source of the input data, the higher the similarity between the inference domain dataset 203 and the training domain dataset 204. Therefore, in alternately training the learnable ISP 202 and the domain classification network, discriminative training of the domain classification network using the inference domain dataset 203 and the training domain dataset 204 may evaluate the similarity between the inference domain dataset 203 and the training domain dataset 204, and the parameters of the learnable ISP 202 may be optimized based on the result of the similarity evaluation. The result of the similarity evaluation herein may include probability that the input data belongs to the inference domain dataset 203 and the training domain dataset 204, in other words, may reflect difficulty of the domain classification network in discriminating the input data.

The method including the similarity evaluation according to the embodiment of the present disclosure has been described above in conjunction with FIG. 2. It should be understood that the above description is exemplary rather than restrictive. For example, performing similarity evaluation on the inference domain data set and the training domain data set may not be limited to the similarity evaluation system based on the domain classification network described above. Other similarity evaluation methods may also be employed to optimize the learnable ISP, such as a similarity evaluation method based on image feature distribution. An exemplary explanation will be provided below in conjunction with FIG. 3.

FIG. 3 illustrates a flowchart of a method for similarity evaluation based on image feature distribution according to an embodiment of the present disclosure. As may be seen from the following description, method 300 described below is a specific embodiment of the similarity evaluation 205 described above in conjunction with FIG. 2. Therefore, the description of similarity evaluation 205 described above in conjunction with FIG. 2 is also applicable to the following description.

As shown in FIG. 3, the method 300 may include the following: in step 301, image features of each piece of inference image data in the inference domain dataset may be extracted to generate a first image feature distribution of the inference domain dataset. In some embodiments, the image features may include at least one of the following: image brightness; image contrast; image sharpness; and image noise intensity. The image brightness refers to the brightness level of an image. The image contrast refers to the measurement value of different brightness levels between the brightest white and the darkest black in the light and dark areas of an image. In other words, it refers to the magnitude of the grayscale contrast of an image, the larger the difference range, the greater the image contrast, and the smaller the difference range, the smaller the image contrast. The image sharpness, sometimes also known as clarity, is an indicator that reflects the clarity of the image plane and the sharpness of the image edges. If the image sharpness is higher, the contrast of details on the image is also higher, making it appear clearer. The image noise intensity refers to the strength of unnecessary or redundant interference information present in image data.

In other embodiments, generating the first image feature distribution of the inference domain dataset may be achieved by statistically analyzing the distribution of image features in each piece of the inference image data. The first image feature distribution may include the distribution of one or more image features in each piece of the inference image data in the inference domain dataset. The first image feature distribution may include but is not limited to being presented in the form of distribution graphs such as histograms, curves, pie charts, and so on. In some further embodiments, statistically analyzing the distribution of image features of each piece of the inference image data may include statistically analyzing the distribution of at least one of the image features of each piece of the inference image data, such as the average value, maximum value, minimum value, distance between the maximum and minimum values and so on.

For example, in an example where the average value of the image features is statistically analyzed and the image features are image brightness, in step 301, the average value of the image brightness of each piece of the inference image data in the inference domain dataset may be extracted. The average value of the image brightness of each piece of the inference image data may then be used as a distribution point to statistically analyze the distribution of the average value of the image brightness of all inference image data in the inference domain dataset, thereby forming a first image feature distribution.

As further shown in FIG. 3, the method 300 may further include: in step 302, extracting image features of each piece of training image data in the training domain dataset to generate a second image feature distribution of the training domain dataset. The image features of the training image data herein may be the same or similar to the image features of the inference image data described in step 301, and will not be further described here.

In some other embodiments, generating the second image feature distribution of the training domain dataset may be achieved by statistically analyzing the distribution of the image features of each piece of the training image data. The second image feature distribution may include the distribution of one or more image features of each piece of the training image data in the training domain dataset. The second image feature distribution may include but is not limited to being presented in the form of distribution graphs such as histograms, curves, pie charts, and so on. In some further embodiments, statistically analyzing the distribution of image features of each piece of the training image data may include statistically analyzing the distribution of at least one of the image features of each piece of the training image data, such as the average value, maximum value, minimum value, distance between the maximum and minimum values and so on.

The process then proceeds to step 303, where a similarity evaluation may be performed between the first image feature distribution and the second image feature distribution. In some embodiments, the selected image feature types and statistical methods for the first image feature distribution and the second image feature distribution may be the same, in order to facilitate similarity evaluation. In other embodiments, evaluation metric of the similarity evaluation may include, for example, chi-square similarity and/or Euclidean distance. In other words, a result of the similarity evaluation between the inference domain dataset and the training domain dataset may be determined by calculating chi-square similarity and/or Euclidean distance between the first image feature distribution and the second image feature distribution. The higher the chi-square similarity between the first image feature distribution and the second image feature distribution, and the smaller the Euclidean distance, the more similar the first image feature distribution and the second image feature distribution are, which in turn indicates that the inference domain dataset and the training domain dataset are more similar.

Based on this, a corresponding loss function may be designed to optimize the parameters of the learnable ISP. For example, when using the Euclidean distance to evaluate the similarity between the first image feature distribution and the second image feature distribution, the Euclidean distance loss function may be directly used to optimize the learnable ISP. For another example, when using the chi-square similarity to evaluate the similarity between the first image feature distribution and the second image feature distribution, the loss function may be designed based on the negative or reciprocal of the chi-square similarity.

The above provides an exemplary description of the similarity evaluation method according to the embodiment of the present disclosure in conjunction with FIG. 3. It may be understood that the above description is exemplary rather than restrictive. For example, within the technical concepts disclosed in the present disclosure, other evaluation metrics besides the chi-square similarity and the Euclidean distance may also be used for similarity evaluation as needed, and this is not limited herein.

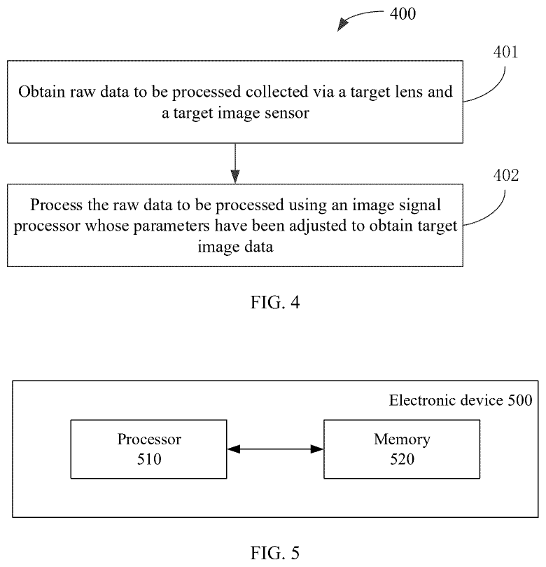

This disclosure also provides a data processing method, which will be described below in conjunction with FIG. 4. FIG. 4 illustrates a flowchart of a data processing method according to an embodiment of the present disclosure. As shown in FIG. 4, a method 400 may include the following: in step 401, raw data to be processed collected via a target lens and a target image sensor may be obtained. The raw data to be processed is image data in RAW format. The obtained raw data to be processed may be one piece of image data or a plurality of pieces of image data.

Next, in step 402, the raw data to be processed may be processed using an image signal processor whose parameters have been adjusted according to any of the methods described above in conjunction with FIG. 1-FIG. 3 to obtain target image data. The target image data may be in RGB data format. The target image data obtained according to an embodiment of the present disclosure may have the same or similar feature distribution as the training domain dataset of the target network model deployed downstream of the ISP. Based on a piece of input raw data to be processed, the ISP may process and generate a piece of corresponding target image data; based on a plurality of pieces of input raw data to be processed, the image signal processor may process and generate a plurality of pieces of corresponding target image data.

In other embodiments, the method 400 may further include: performing visual task processing on the target image data using the target network model. The visual tasks may include, for example, one or more of object detection, object recognition, segmentation, classification and so on. It may be understood that the learnable ISP obtained through training by using the method according to any one of FIG. 1 to FIG. 3 may learn the parameters of the ISP, of which the data style is close to that of the training data of the target network model. As such the ISP whose parameter have been adjusted may normalize data style of raw image data collected by different lenses and image sensors used in actual deployment scenarios to data style of the training domain dataset. Consequently, the target network model may achieve better inference performance in actual deployment scenarios without retraining.

From the above description, those skilled in the art may understand that the embodiments of the present disclosure, by using the sample dataset and the training domain dataset to train the learnable ISP, enable the learnable ISP to learn the image style of the training domain dataset. This, in turn, enables the ISP whose parameters have been adjusted, to normalize RAW images collected by different target lenses and/or different target image sensors, which is beneficial for improving the inference performance of the target network model in different deployments. It may be understood that the solution of the embodiments of the present disclosure improves inference performance by focusing on the data itself, rather than training a CV model. Therefore, there is no need to repeatedly train the CV model, saving a lot of time and manpower costs.

Furthermore, in some embodiments, by performing the similarity evaluation on the inference domain dataset and the training domain dataset, the parameters of the learnable ISP may be optimized based on a result of the similarity evaluation to optimize the parameters of the ISP, so that the style of the target image data generated by the ISP, whose parameters have been optimized, is highly consistent with that of the training data of the target network model.

Based on the above description, those skilled in the art may also understand that the present disclosure also discloses an electronic device. The following will provide an exemplary explanation in conjunction with FIG. 5.

FIG. 5 illustrates a schematic block diagram of an electronic device according to an embodiment of the present disclosure. As shown in FIG. 5, an electronic device 500 may include a processor 510 configured to execute program instructions. The processor 510 may be a general-purpose processor, a dedicated processor, or a combination of these two. Furthermore, the electronic device 500 disclosed herein may also include a memory 520, which may store program instructions. When the program instructions are loaded and executed by the processor 510, the processor 510 executes the method for adjusting the parameters of the ISP described above in conjunction with any of FIGS. 1-3, or the data processing method described above in conjunction with FIG. 4.

In some implementation scenarios, the electronic device 500 may include a device with image processing capabilities, such as a computer, a personal computer (PC), an image analyzer, or other terminal devices. In actual applications, the electronic device 500 may consist of a single device with multiple functions described above, or may consist of a combination of multiple devices with partial functions. The solution of the present disclosure does not limit the design of the structure that electronic device 500 may have.

Regarding the aforementioned program instructions, the present disclosure also discloses a computer-readable storage medium storing computer-readable instructions, which, when executed by one or more processors, implement the method for adjusting image signal processor parameters as described above in conjunction with any of FIGS. 1-3, or the data processing method as described above in conjunction with FIG. 4.

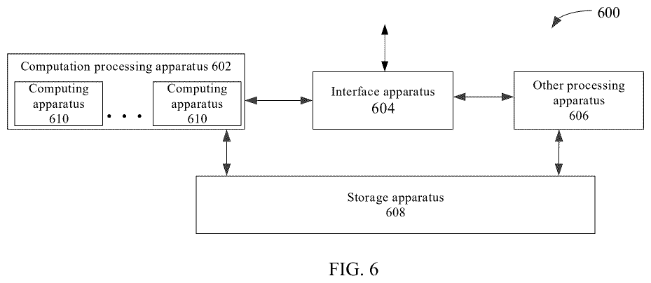

FIG. 6 illustrates a diagram of a structure of a combined processing device according to an embodiment of the present disclosure. The combined processing apparatus 600 may implement or include the electronic device of the present disclosure described above. As shown in FIG. 6, the combined processing apparatus 600 may include a computation processing apparatus 602, an interface apparatus 604, other processing apparatus 606, and a storage apparatus 608. Depending on different application scenarios, the computation processing apparatus 602 may include one or more computing apparatuses 610. These computing apparatuses 610 may be configured to perform various computing operations, including but not limited to various operations involved in machine learning within the field of artificial intelligence, such as the various operations in the learnable ISP of the present disclosure.

In various embodiments, the computation processing apparatus 602 of the present disclosure may be configured to perform user-specified operations. In an exemplary application, the computation processing apparatus 602 may be implemented as a single-core AI processor or a multi-core AI processor. Similarly, one or more computing apparatuses 610 included in the computation processing apparatus may also be implemented as an AI processor core or a partial hardware structure of an AI processor core. When multiple computing apparatuses 610 are implemented as the AI processor cores or partial hardware structures of the AI processor cores, the computation processing apparatus 602 of the present disclosure may be considered to have a single-core structure or a homogeneous multi-core structure.

In exemplary operation, the computation processing apparatus 602 of the present disclosure may interact with the other processing apparatus 606 via the interface apparatus 604 to jointly complete user-specified operations. According to different implementation methods, the other processing apparatus 606 of the present disclosure may include one or more types of processors among general-purpose and/or dedicated processors, such as a central processing unit (CPU), a graphics processing unit (GPU), an AI processor, and so on. These processors may include, but are not limited to, digital signal processors (DSPs), application specific integrated circuits (ASICs), field-programmable gate arrays (FPGAs), or other programmable logic devices, discrete gate or transistor logic devices, discrete hardware components or the like, and their number may be determined based on actual needs. As mentioned above, only with respect to the computation processing apparatus 602 of the present disclosure, it may be viewed as having a single-core structure or a homogeneous multi-core structure. However, when the computation processing apparatus 602 and the other processing apparatus 606 are considered together, they are considered to form a heterogeneous multi-core structure.

In one or more embodiments, the other processing apparatus 606 may serve as an interface between the computation processing apparatus 602 of the present disclosure (which may be embodied as a related computing apparatus of artificial intelligence such as neural network computation) and external data and control, performing basic control including, but not limited to, data transfer, starting and/or stopping the computing device and so on. In other embodiments, the other processing apparatus 606 may also collaborate with the computation processing apparatus 602 to jointly complete computing tasks.

In one or more embodiments, the interface apparatus 604 may be used to transfer data and control instructions between the computation processing apparatus 602 and other processing apparatus 606. For example, the computation processing apparatus 602 may obtain input data from the other processing apparatus 606 via the interface apparatus 604 and write the data into the on-chip storage apparatus (or memory) of the computation processing apparatus. Further, the computation processing apparatus 602 may obtain control instructions from the other processing apparatus 606 via the interface apparatus 604 and write them to an on-chip control cache of the computation processing apparatus. Alternatively or optionally, the interface apparatus 604 may also read data from the storage apparatus of the computation processing apparatus and transmit it to other processing apparatus.

Additionally or optionally, the combined processing apparatus 600 of the present disclosure may also include a storage apparatus 608. As shown in figure, the storage apparatus 608 is connected to the computation processing apparatus 602 and other processing apparatus 606, respectively. In one or more embodiments, the storage apparatus 608 may be used to save data of computation processing apparatus 602 and/or other processing apparatus 606. For example, the data may be data that cannot be fully saved in an internal or on-chip storage apparatus of the computation processing apparatus or other processing apparatus.

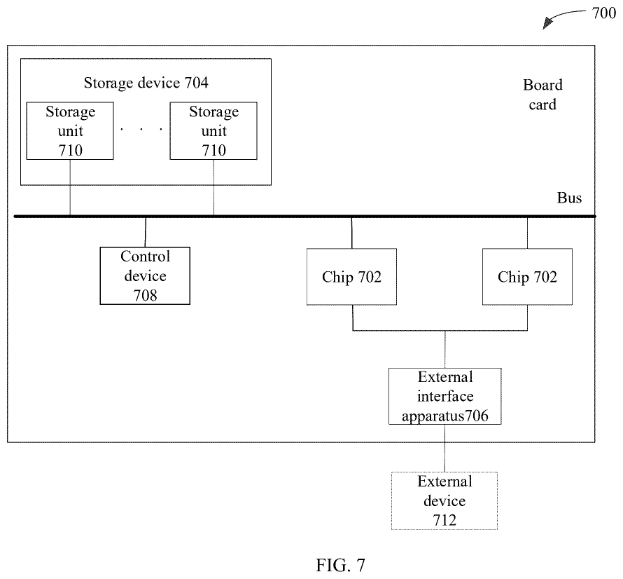

In some embodiments, the present disclosure further discloses a chip (e.g., a chip 702 shown in FIG. 7). In one implementation, the chip is a system on chip (SoC) and integrates one or more combined processing apparatuses 600 as shown in FIG. 6. The chip may be connected to other related components via an external interface apparatus (e.g., an external interface apparatus 706 shown in FIG. 7). The related component may be, for example, a camera, display, mouse, keyboard, network card, or wireless fidelity (Wi-Fi) interface. In some application scenarios, the chip may be integrated with other processing units (e.g., a video codec) and/or interface modules, such as a dynamic random-access memory (DRAM) interface. In some examples, the present disclosure also discloses a chip package structure which includes the aforementioned chip. In some embodiments, the present disclosure further discloses a board card that includes the aforementioned chip package structure. This board card will be described in detail below with reference to FIG. 7.

FIG. 7 illustrates a schematic diagram of a structure of a board card according to an embodiment of the present disclosure, which may be configured with or include the electronic device disclosed herein. As shown in FIG. 7, the board card 700 may include a storage device 704 for storing data, which includes one or more storage units 710. The storage device 704 may be connected to the control device 708 and the chip 702 described above, for data transmission, via a bus or other means. Furthermore, the board card 700 may also include an external interface apparatus 706, which is configured to relay or transfer data between the chip (or the chip in the chip package) and an external device 712. For example, the data to be processed may be transmitted from the external device to the chip 702 via the external interface apparatus 706. For another example, the computation results of the chip 702 may be transmitted back to the external device 712 via the external interface apparatus 706. According to different application scenarios, the external interface apparatus 706 may have different interface forms, such as a standard peripheral component interconnect express (PCIE) interface and so on.

In one or more embodiments, the control device 708 in the board card 700 of the present disclosure may be configured to regulate and control the state of the chip 702. To this end, in an application scenario, the control device 708 may include a micro controller unit (MCU) to regulate and control the working state of the chip 702.

It should be noted that, for the purpose of conciseness, the present disclosure describes some methods and embodiments thereof as a series of actions and combinations thereof, but those skilled in the art may understand that the solutions of the present disclosure are not limited by the order of the described actions. Thus, in light of the disclosure or teachings of the present disclosure, those skilled in the art will appreciate that certain steps therein may be performed in other sequences or simultaneously. Further, those skilled in the art can appreciate that the embodiments described in this disclosure can be viewed as being optional, in other words, acts or modules involved therein are not necessarily required for implementation of certain one or more of the schemes of this disclosure. In addition, depending on the different schemes, the present disclosure also has different emphases on the description of some embodiments. In view of this, those skilled in the art can understand the parts not described in detail in one embodiment of this disclosure can also be referred to in the relevant descriptions of other embodiments.

In terms of specific implementation, based on the disclosure and teachings of the present disclosure, those skilled in the art may understand that several embodiments disclosed in the present disclosure may also be implemented in other manners not disclosed herein. For example, with respect to the various devices or units in the aforementioned electronic device or apparatus embodiment, the present disclosure divides them based on the consideration of logical functions, and there may be other division methods in actual implementation. For another example, a plurality of units or components may be combined or integrated into another system, or certain features or functions within a unit or component may be selectively disabled. In terms of connection relationships between different units or components, the connections discussed above in connection with the figures may be direct or indirect couplings between the units or components. In some scenarios, the aforementioned direct or indirect coupling involves a communication connection utilizing an interface that can support electrical, optical, acoustical, magnetic, or other forms of signal transmission.

In the present disclosure, the units described as separate components may or may not be physically separate, and the components shown as units may or may not be physical units. The aforementioned components or units can be located in the same location or distributed across a plurality of network units. In addition, according to actual needs, some or all of the units can be selected to achieve the purpose of the solution described in this disclosed embodiment. Additionally, in some scenarios, a plurality of units in an embodiment of the present disclosure may be integrated into one unit or physically exist separately for each unit.

In some implementation scenarios, the integrated units mentioned above may be implemented in the form of a software program module. If the integrated units are implemented in the form of software program modules and sold or used as an independent product, the integrated units may be stored in a computer-readable memory. Based on this, when the solution of the present disclosure is embodied in the form of a software product (such as a computer-readable storage medium), the software product may be stored in a memory, which may include several instructions to enable a computer device (such as a personal computer, a server or a network device, and the like) to perform some or all steps of the method described in the embodiment of the present disclosure. The aforementioned memory may include but is not limited to various media that may store program codes, such as a USB flash drive, a flash drive, a read only memory (ROM), a random access memory (RAM), a mobile hard disk, a magnetic disk or an optical disk and so on.

In other scenarios, the integrated unit may also be implemented in a form of hardware, in other words, a specific hardware circuit, which may include a digital circuit and/or an analog circuit. The physical implementation of the hardware structure of a circuit can include but is not limited to physical devices, which may include but are not limited to transistors or memristors and the like. In view of this, various apparatuses described herein (such as computing apparatuses or other processing apparatuses) may be implemented through appropriate hardware processors, such as CPU, GPU, FPGA, DSP, ASIC and so on. Furthermore, the aforementioned storage unit or storage apparatus may be any appropriate storage medium (including magnetic storage medium or magneto-optical storage medium, and so on), which may be, for example, a resistive random access memory (RRAM), a dynamic random access memory (DRAM), a static random access memory (SRAM), an enhanced dynamic random access memory (EDRAM), a high bandwidth memory (HBM), a hybrid memory cube (HMC), an ROM, an RAM and so on.

The foregoing may be better understood according to the following articles:

Article A1. A method for adjusting parameters of an image signal processor, including: obtaining a sample dataset formed from raw image data collected via a target lens and a target image sensor;
obtaining a training domain dataset for training a target network model; training a learnable image signal processing model using the sample dataset and the training domain dataset; and
configuring parameters of the trained learnable image signal processing model to the image signal processor.

Article A2. The method according to article A1, wherein training the learnable image signal processing model using the sample dataset and the training domain dataset includes: inputting the sample dataset into the learnable image signal processing model to obtain an inference domain dataset; and
performing a similarity evaluation on the inference domain dataset and the training domain dataset to adjust the parameters of the learnable image signal processing model based on a result of the similarity evaluation.

Article A3. The method of article A2, further including: forming a generative adversarial network based on the learnable image signal processing model and a domain classification network; and
alternately training the learnable image signal processing model and the domain classification network, where the domain classification network is discriminatively trained using the inference domain dataset and the training domain dataset to evaluate the similarity between the inference domain dataset and the training domain dataset.

Article A4. The method of article A3, where the domain classification network includes a VGG network model or a ResNet network model.

Article A5. The method of article A2, where performing the similarity evaluation on the inference domain dataset and the training domain dataset includes:
extracting image features of each piece of inference image data in the inference domain dataset to generate a first image feature distribution of the inference domain dataset;

extracting image features of each piece of training image data in the training domain dataset to generate a second image feature distribution of the training domain dataset; and
performing a similarity evaluation on the first image feature distribution and the second image feature distribution.

Article A6. The method of article A5, where the image features include at least one of the following:
image brightness;
image contrast;
image sharpness; and
image noise intensity.

Article A7. The method of article A5 or article A6, where evaluation metric of the similarity evaluation includes chi-square similarity and/or Euclidean distance.

Article A8. The method of any of the articles A1-A7, before training the learnable image signal processing model, the method further including:
generating the learnable image signal processing model based on the image signal processor.

Article A9. The method of article A8, where generating the learnable image signal processing model based on the image signal processor includes:
performing differentiable processing on the image signal processor to obtain the learnable image signal processing model.

Article A10. A data processing method, including:
obtaining raw data to be processed collected via a target lens and a target image sensor; and processing the raw data to be processed using an image signal processor whose parameters have been adjusted according to the method of any one of articles Al-A9 to obtain target image data.

Article A11. The data processing method of article A10, further including: performing visual task processing on the target image data using a target network model.

Article A12. An electronic device, including:
a processor configured to execute program instructions; and
a memory storing the program instructions, which, when loaded and executed by the processor, cause the processor to perform the method for adjusting parameters of an image signal processor according to any one of articles A1-A9, or the data processing method according to article A10 or A11.

Article A13. A computer-readable storage medium having computer-readable instructions stored thereon, which, when executed by one or more processors, implement the method for adjusting parameters of an image signal processor according to any one of articles A1-A9, or the data processing method according to article A10 or A11.

While various embodiments of the present disclosure have been shown and described herein, it will be obvious to those skilled in the art that such embodiments are provided by way of example only. Numerous modifications, variations, and substitutions may occur to those skilled in the art without departing from the spirit and scope of this disclosure. It should be understood that various alternatives to the embodiments described herein may be employed in practicing this disclosure. The appended claims are intended to define the scope of this disclosure and are intended to cover equivalents and alternatives within the scope of these claims.

1. A method for adjusting parameters of an image signal processor, comprising:
obtaining a sample dataset formed from raw image data collected via a target lens and a target image sensor;
obtaining a training domain dataset for training a target network model;
training a learnable image signal processing model using the sample dataset and the training domain dataset; and
configuring parameters of the trained learnable image signal processing model to the image signal processor.

2. The method of claim 1, wherein the training of the learnable image signal processing model using the sample dataset and the training domain dataset comprises:
inputting the sample dataset into the learnable image signal processing model to obtain an inference domain dataset; and
performing a similarity evaluation on the inference domain dataset and the training domain dataset to adjust the parameters of the learnable image signal processing model based on a similarity evaluation result.

3. The method of claim 2, further comprising:
forming a generative adversarial network based on the learnable image signal processing model and a domain classification network; and
alternatingly training the learnable image signal processing model and the domain classification network, wherein the domain classification network is discriminatively trained using the inference domain dataset and the training domain dataset to evaluate the similarity between the inference domain dataset and the training domain dataset.

4. The method of claim 3, wherein the domain classification network comprises a visual geometry group network model or a ResNet network model.

5. The method of claim 2, wherein the performing of the similarity evaluation on the inference domain dataset and the training domain dataset comprises:
extracting image features of each piece of inference image data in the inference domain dataset to generate a first image feature distribution of the inference domain dataset;
extracting image features of each piece of training image data in the training domain dataset to generate a second image feature distribution of the training domain dataset; and
performing a similarity evaluation on the first image feature distribution and the second image feature distribution.

6. The method of claim 5, wherein the image features comprise at least one of the following:
image brightness;
image contrast;
image sharpness; and
image noise intensity.

7. The method of claim 5, wherein evaluation metric of the similarity evaluation comprises chi-square similarity and/or Euclidean distance.

8. The method of claim 1, further comprising, before training the learnable image signal processing model, generating the learnable image signal processing model based on the image signal processor.

9. The method of claim 8, wherein the generating of the learnable image signal processing model based on the image signal processor comprises:
performing differentiable processing on the image signal processor to obtain the learnable image signal processing model.

10. A data processing method comprising:
obtaining raw data to be processed collected via a target lens and a target image sensor; and
processing the raw data to be processed using an image signal processor whose parameters have been adjusted according to the method of claim 1, to obtain target image data.

11. The method of claim 10, further comprising:
performing visual task processing on the target image data using a target network model.

12. An electronic device comprising:
a processor configured to execute program instructions; and
a memory configured to store the program instructions, which, when loaded and executed by the processor, enable the processor to perform the method for adjusting parameters of an image signal processor according to claim 1.

13. A non-transitory computer-readable storage medium having computer-readable instructions stored thereon, which, when executed by one or more processors, implement the method for adjusting parameters of an image signal processor according to claim 1.

14. An electronic device comprising:
a processor configured to execute program instructions; and
a memory configured to store the program instructions, which, when loaded and executed by the processor, enable the processor to perform the data processing method according to claim 10.

15. A non-transitory computer-readable storage medium having computer-readable instructions stored thereon, which, when executed by one or more processors, implement the data processing method according to claim 10.

16. The method of claim 6, wherein evaluation metric of the similarity evaluation comprises chi-square similarity and/or Euclidean distance.

17. The method of claim 2, further comprising, before training the learnable image signal processing model, generating the learnable image signal processing model based on the image signal processor.

18. The method of claim 17, wherein the generating of the learnable image signal processing model based on the image signal processor comprises:
performing differentiable processing on the image signal processor to obtain the learnable image signal processing model.

19. The method of claim 3, further comprising, before training the learnable image signal processing model, generating the learnable image signal processing model based on the image signal processor.

20. The method of claim 19, wherein the generating of the learnable image signal processing model based on the image signal processor comprises:
performing differentiable processing on the image signal processor to obtain the learnable image signal processing model.
